(19) United States
(12) Patent Application Publication
(10) Pub. No.: US 2010/0058236 A1
(43) Pub. Date: Mar. 4, 2010

(54) Information processing apparatus and information processing method

(75) Inventors: Naoto Inoue, Tokyo (JP); Kazunori Ohmura, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/583,612

(22) Filed: Aug. 24, 2009

(30) Foreign Application Priority Data
Aug. 29, 2008 (JP) P2008-221525

(51) Int. Cl. G06F 3/048

(52) U.S. Cl. 715/810

(57) ABSTRACT

An information processing apparatus has a content detecting unit which detects a piece of content data having a piece of time information representing a time point that is a predetermined cycle before or after with respect to a time point represented by a piece of time information added to a piece of content data being reproduced, and a display control unit which displays, on a display screen, at least one of a piece of attribute information added to the piece of content data detected by the content detecting unit and an image included in the piece of content data as well as at least one of a piece of attribute information added to the piece of content data being reproduced and an image included in the piece of content data being reproduced.

### CROSS-REFERENCE TO RELATED APPLICATION

The present application claims priority from Japanese Patent Application No. JP 2008-221525 filed in the Japanese Patent Office on Aug. 29, 2008, the entire content of which is incorporated herein by reference.

### BACKGROUND OF THE INVENTION

1. Field of the Invention

The present invention relates to an information processing apparatus and an information processing method.

2. Description of the Related Art

Since digital cameras and digital video cameras are widely used, a lot of personal events can be saved as digital data. For example, it is enjoyable to review photographs which have been developed and put into an album, and users potentially get interested in such content. However, very few pieces of content data are practically put into an album or the like, and most of the acquired pieces of content data are generally saved in PC (personal computer) and thus an opportunity for viewing them is limited. The limitation of the opportunity for viewing is true not only for pieces of content data which are recorded and acquired actively by users but also to external piece of content data which are yet unknown by the users.

On the other hand, Japanese Patent Application Laid-Open Nos. 2007-235238 and 2007-264763 (Patent Documents 1 and 2) disclose information processing apparatus which increase opportunities to view a lot of stored pieces of content data. In these information processing apparatus, summary of a content represented by a piece of content data is created, and pieces of content data are associated with each other so that detection of the piece of content data is simplified. Further, a technique, which extracts user's preferences using uses' profiles and detects a piece of content data which match with the preferences, is also developed.

### SUMMARY OF THE INVENTION

In these techniques, however, it is likely to repeatedly detect only some pieces of content data which match with a summary, a relationship and a piece of preference information, for example. If pieces of content data to be detected are limited as described, even if users get interested in various content, the users view only some content and may forget other interesting contents.

Therefore, the present invention is made in view of the abovementioned problems and the object thereof is to provide new and improved information processing apparatus and information processing method capable of reducing a possibility of dominantly displaying some pieces of content data and capable of presenting various pieces of content data, which are expected to interest users, in a plurality of pieces of content data.

According to an embodiment of the present invention, there is provided an information processing apparatus including: a content detecting unit which detects a piece of content data having a piece of time information representing a time point that is a predetermined cycle before or after with respect to a time point represented by a piece of time information added to a piece of content data being reproduced; and a display control unit which displays, on a display screen, at least one of a piece of attribute information added to the piece of content data detected by the content detecting unit and an image included in said piece of content data as well as at least one of a piece of attribute information added to the piece of content data being reproduced and an image included in said piece of content data.

In this configuration, the content detecting unit can detect another piece of content data having a piece of time information representing a time point that is a predetermined cycle before or after with respect to a time point represented by the piece of time information added to a piece of content data being reproduced. The display control unit can display, on the display screen, an image and/or a piece of attribute information of the detected another piece of content data as well as an image and/or a piece of attribute information of the piece of content data being reproduced on a display screen. In this configuration, therefore, not only the piece of content data being reproduced but also a piece of content data having predetermined cyclic nature in time with respect to the piece of content data being reproduced can be presented to the user.

The information processing apparatus may further include a first cycle determining unit which determines the predetermined cycle corresponding to an operating time length of the information processing apparatus.

The first cycle determining unit may determine the predetermined cycle longer as the operating time length of the information processing apparatus becomes longer.

The information processing apparatus may further include a second cycle determining unit which determines the predetermined cycle based on the piece of attribute information added to the piece of content data being reproduced.

Further, the content detecting unit may detect a piece of content data having a piece of attribute information that has a predetermined relationship with the piece of attribute information added to the piece of content data being reproduced, and the information processing apparatus may further include a relationship determining unit which determines the predetermined relationship based on the predetermined cycle.

One cycle of the predetermined cycle may be a repetition unit of the calendar.

One cycle of the predetermined cycle may be a day, a week, a month or a year.

The content detecting unit may detect a plurality of pieces of content data, and the display control unit may display, on the display screen, at least one of the piece of attribute information added to the piece of content data detected by the content detecting unit and an image included in the piece of content data in a list showing the predetermined cycles.

According to another embodiment of the present invention, there is provided an information processing method including the steps of: detecting a piece of content data having a piece of time information representing a time point that is a predetermined cycle before or after with respect to a time point represented by a piece of time information added to a piece of content data being reproduced; and displaying, on a display screen, at least one of a piece of attribute information added to the piece of content data detected at the content detecting step and an image included in said piece of content data as well as at least one of a piece of attribute information added to the piece of content data being reproduced and an image included in the piece of content data being reproduced.

According to the embodiments of the present invention described above, it is possible to reduce the possibility of dominantly displaying some pieces of content data and possible to present various pieces of content data, which are expected to interest users, in a plurality of pieces of content data.

### BRIEF DESCRIPTION OF THE DRAWINGS

FIG. 1 is an explanatory diagram illustrating a configuration of a display apparatus according to a first embodiment of the present invention;

FIG. 2 is an explanatory diagram illustrating a piece of content data to be reproduced by the display apparatus according to the first embodiment;

FIG. 3 is an explanatory diagram illustrating detection in the display apparatus according to the first embodiment;

FIG. 4 is an explanatory diagram illustrating detection in the display apparatus according to the first embodiment;

FIG. 5 is an explanatory diagram illustrating detection in the display apparatus according to the first embodiment;

FIG. 6 is an explanatory diagram illustrating detection in the display apparatus according to the first embodiment;

FIG. 7 is an explanatory diagram illustrating a cycle to be determined by the display apparatus according to the first embodiment;

FIG. 8 is an explanatory diagram illustrating a cycle to be determined by the display apparatus according to the first embodiment;

FIG. 9 is an explanatory diagram illustrating an operation of the display apparatus according to the first embodiment; and

FIG. 10 is an explanatory diagram illustrating one example of the operation of the display apparatus according to the first embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

An information processing apparatus according to an embodiment of the present invention described below reproduces and presents one piece of content data to a user, and at that time, can preset a piece of content data having predetermined temporal cyclic nature with respect to the piece of content data to the user.

As the information processing apparatus, various application examples are considered according to the content of content data. That is to say, when a piece of content data is music, the information processing apparatus can be applied to a sound reproducing apparatus. When a piece of content data is image such as moving image and still image, the information processing apparatus can be applied to a display apparatus such as a television. However, the content of a piece of content data do not limit an applicable scope of the information processing apparatus according to the embodiment of the present invention. For example, it goes without saying that the information processing apparatus can be applied to information processing apparatus which can provide plural types of pieces of content data to users and general-purpose devices such as computers.

For convenience of the description, a case where the information processing apparatus according to the embodiment of the present invention is applied to a display apparatus is described as an example. For easy understanding of the embodiment, the description follows the order below.

### <First Embodiment>

### [1. Configuration of Display Apparatus]

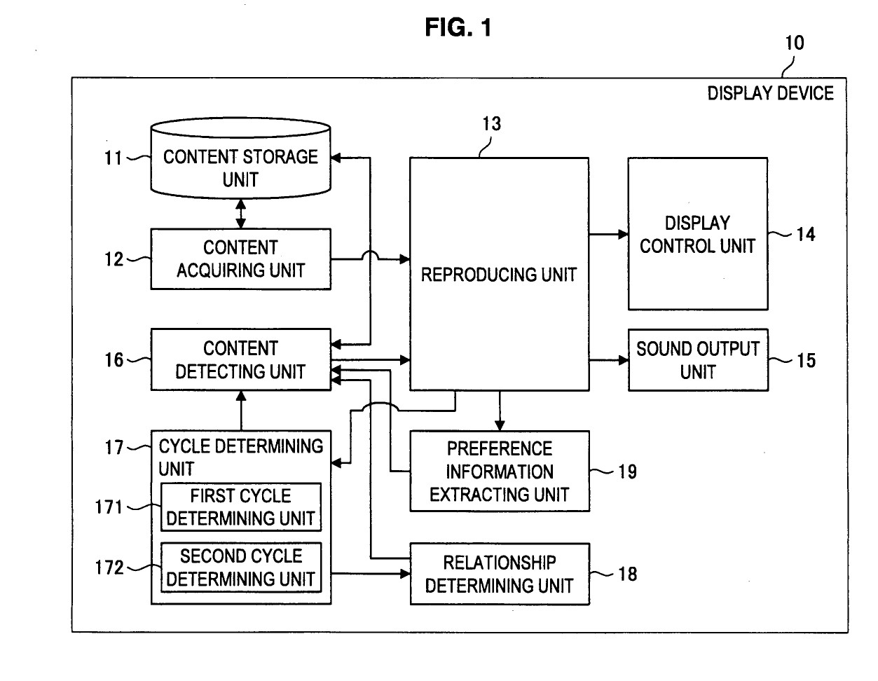

FIGS. 1 to 8

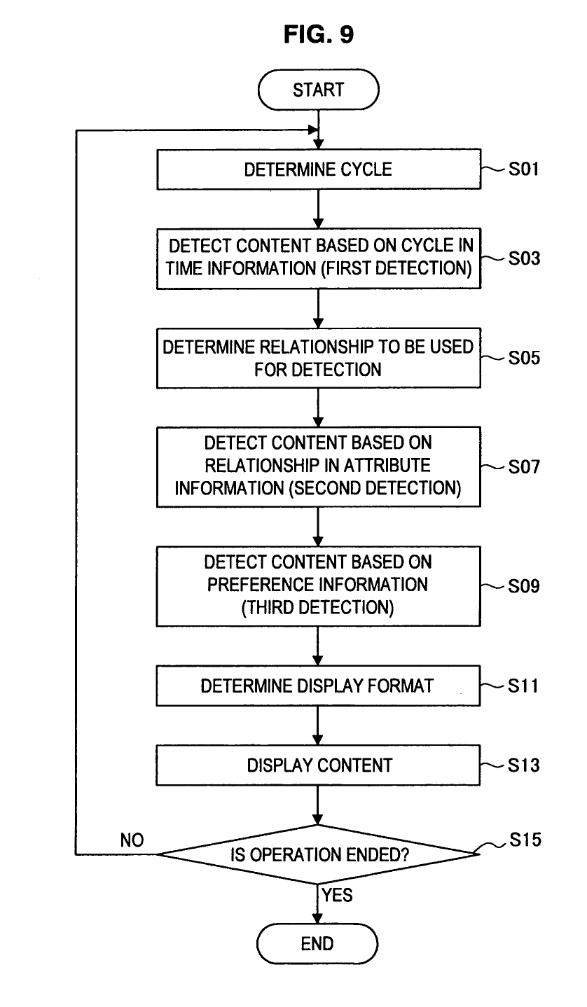

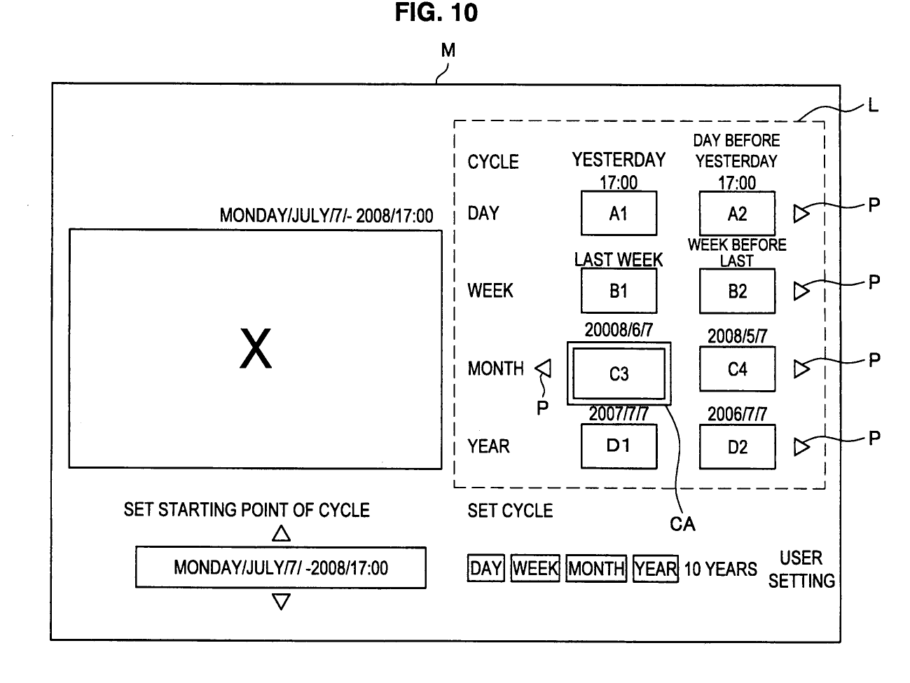

### [2. Operation of Display Apparatus] FIG. 9

### [3. Operational Example of Display Apparatus]

FIG. 10

### [4. Example of Effect of Display Apparatus]

### First Embodiment

### 1. Configuration of Display Apparatus

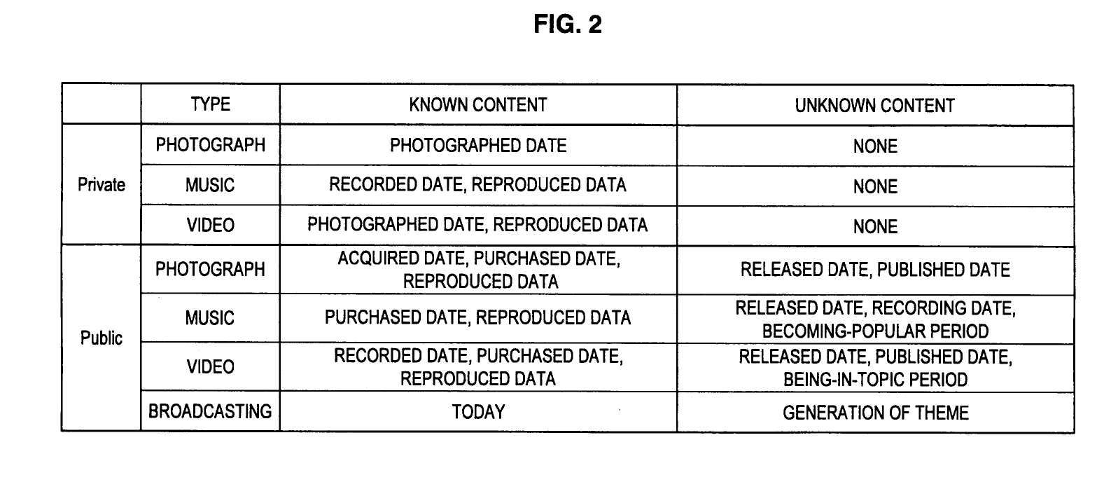

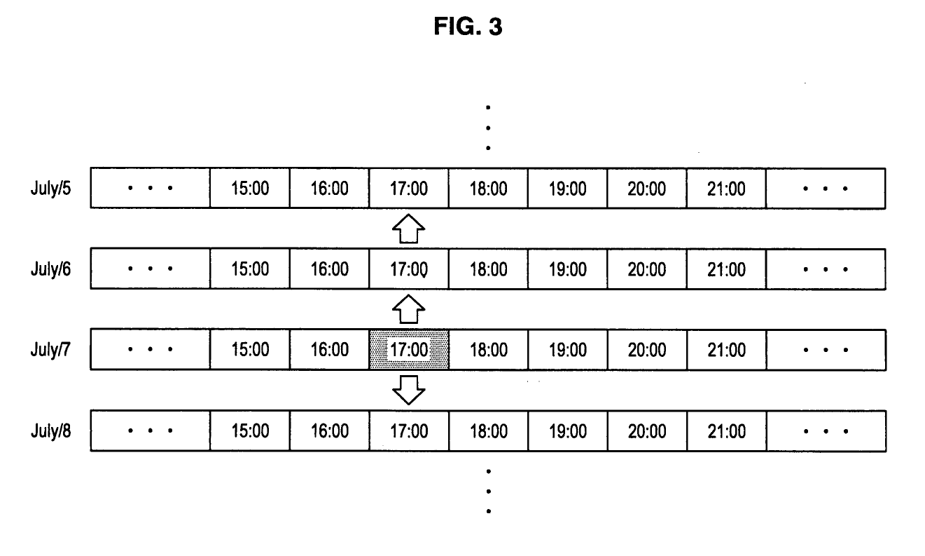

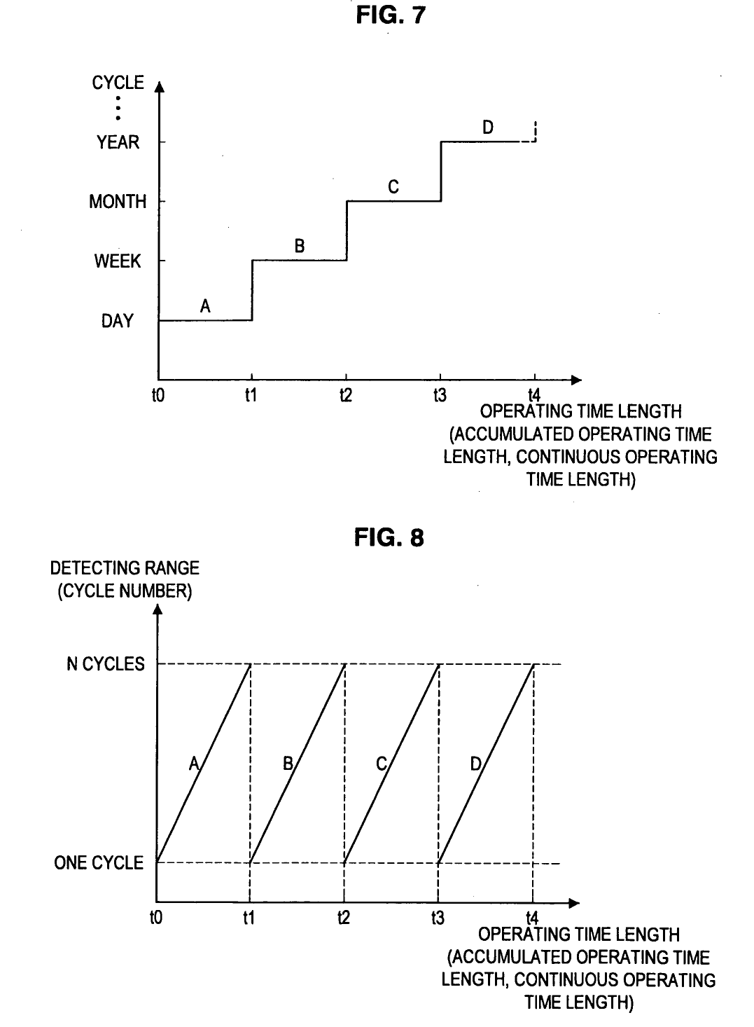

A configuration of a display apparatus according to a first embodiment of the present invention is described with reference to FIGS. 1 to 8. FIG. 1 is an explanatory diagram illustrating the configuration of the display apparatus according to the first embodiment of the present invention. FIG. 2 is an explanatory diagram illustrating pieces of content data to be reproduced by the display apparatus according to the first embodiment. FIGS. 3 to 6 are explanatory diagrams illustrating detection in the display apparatus according to the first embodiment. FIGS. 7 and 8 are explanatory diagram illustrating cycles determined by the display apparatus according to the embodiment.

The display apparatus 10 according to the first embodiment reproduces a piece of content data. When the piece of content data includes a moving image or a still image, the display apparatus 10 displays the images, and when the piece of content data includes sounds, it outputs the sounds.

Examples of such a display apparatus include Cathode Ray Tube (CRT), Liquid Crystal Display (LCD), Plasma Display Panel (PDP), Field Emission Display (FED), Organic Electroluminescence Display (organic EL, OELD), and video projector. Further, other examples of the display apparatus 10 include display apparatus of various forms for displaying content, such as a general-purpose computer, a notebook computer, a PDA (Personal Digital Assistant) and a mobile telephone. That is to say, any display apparatus can be used as the display apparatus 10 as long as it can reproduce content and can display images of the content or output sound. Hereinafter, the display apparatus according to the first embodiment is called simply the “display apparatus”.

The piece of content data includes, for example, at least one of images, which are moving images or still images, and sounds. The piece of content data may be data including moving images and sounds like a film, or image data including only still images, or may be music/voice data including only sounds, or may be text data. That is to say, the piece of content data may be various data as long as their content can be provided to users in the format of an image, a sound or the like.

The image apparatus 10 according to the first embodiment has, as shown in FIG. 1, a content storage unit 11, a content acquiring unit 12, a reproducing unit 13, a display control unit 14, a sound output unit 16, a content detecting unit 16, a cycle determining unit 17, a relationship determining unit 18 and a preference information extracting unit 19. The respective components are described below.

The content storage unit 11 records one or more pieces of content data which can be reproduced by the display apparatus 10. In the first embodiment, a case where the content storage unit 11 is contained in the display apparatus 10 is illustrated, but it is not limited to this example, and the content storage unit 11 may be a recording apparatus to be externally connected to the display apparatus 10 or a storage unit contained in an external apparatus. A type or content of the piece of content data to be reproduced by the display apparatus 10 is not particularly limited, but the piece of content data includes at least one content of images (still images and moving images) and sounds as described above.

To each pieces of content data, a piece of “Attribute information” representing attribute of the piece of content data is added. The attribute of a pieces of content data includes a name of the content, a genre of the content, a summary of the content, information about performers and producers, target viewers of the content, information relating to the content to be provided to viewers, broadcasting format and acquiring method and broadcasting channel, a type of the content (for example, moving image, still image or sound), and a production place of the content, for example. Examples of the pieces of attribute information are metadata and EPS (electronic program guide) added to a piece of content data.

Further, a piece of “time information” representing information about time relating to the piece of content data is added to each piece of content data. The time relating to the content basically includes a time length and a time point, for example.

An example of the time length is a time length for reproducing the piece of content data. On the other hand, examples of the time point includes a time point at which the piece of content data is created, a time point at which an image or a sound in the piece of content data is recorded, a time point at which the piece of content data is released or published, a time point at which the piece of content data is acquired, a time point at which the piece of content data becomes popular, and a time point at which the piece of content data is reproduced at previous time, for example. The time point relating to the piece of content data is, however, not limited to these example, and various time points relating to the piece of content data may be included. The time point may be expressed by one of or a plurality of year, month, day, day of the week and time, for example. The time point may be specified specifically in time, but only year, month, day and a day of the week; only year; only year and month; only month; only month and day; only day; only time; only a day of the week; or the like may be specified. In this case, it can be said that the time point expresses a predetermined period. More specifically, when the created date of one piece of content data is Monday/Jul. 7, 2007, the time point expressed in the piece of time information is also Monday/Jul. 7, 2007. In this case, the time point expresses a specific year, month, day and a day of the week, and does not include time. Similarly when the creation time of one piece of content data is Monday/Jul. 7, 2007/17:00, the time point expressed in the piece of time information is also Monday/Jul. 7, 2007/17:00. In this case, the time point expresses a specific year, month, day and a day of the week, and hour of the time, and does not include a minute of the time. It is preferable that the time point specifies at least one of year, month, day, a day of the week, hour, minute and second like these examples. At this time, when the time point specifies a day, it is desirable that the time point specifies calendar unit which is larger than the day of the week (namely, year and month).

Examples of the piece of time information representing the time point or the like include metadata and EPS (electronic program guide) added to a piece of content data. The piece of time information may be included in the piece of attribute information. However, for convenience of the description, the piece of time information and the piece of attribute information are described separately.

The content acquiring unit 12 acquires a piece of content data to be reproduced by the display apparatus 10.

The content acquiring unit 12 acquires a piece of content data from an acquisition source specified by a user's operation of a remote controller or an operation button, for example in response to the user's operation. At this time, the content data acquiring source is not particularly limited. Examples of the acquiring source includes the abovementioned content storage unit 11, broadcast waves such as ground waves and satellite waves, and a content distributing server (not shown) which publishes content on a network such as the Internet.

An example of a piece of content data acquired by the content acquiring unit 12 (including a piece of content data recorded in the content storage unit 11) is described below with reference to FIG. 2.

As shown in FIG. 2, the piece of content data basically includes personal data (Private) and data usable by public or specific groups (Public), for example. Examples of the types of the personal data content include photograph (one example of still images), music (one example of sounds), and video (one example of moving images), for example. On the other hand, examples of the type of public data content include photograph, music, video, and broadcast (or any broadcast format), for example. These pieces of content data are roughly divided into “known content” and “unknown content”. The known content means a content which a user is estimated to be aware of directly or indirectly regardless of whether the user remembers the content. The unknown content means a content which a user is estimated not to be aware of directly or indirectly. FIG. 2 illustrates one example of the piece of time information that represents the time point and is added to the known piece of content data or the unknown piece of content data. For example, a piece of time information such as a photographed date may be added to personal photograph data. On the other hand, in the case of known content, a piece of time information such as date of acquiring data, date of purchasing data and date of reproducing data may be added to the public photograph data, and in the case of the unknown content, a piece of time information such as release date and published date of data may be added to the public photograph data. Since the personal data is data of content which a user is estimated to be aware of directly or indirectly, normally it is assumed to be data of known content. In FIG. 2, therefore, personal and unknown content is not illustrated. However, the piece of content data shown in FIG. 2 is only illustrative and the piece of content data acquired by the content acquiring unit 12 is not limited to the examples.

Here, the piece of content data acquired by the content acquiring unit 12 may be in a format, in which a content included in the piece of content data can not be normally read, such as a combination of a plurality of pieces of abovementioned data, compressed data, or encoded data. If the piece of content data is in such format, the content acquiring unit 12 may convert the acquired piece of content data into a readable format, by converting back to the plurality of pieces of information, decompressing or decoding. Further, the content acquiring unit 12 may serve as a tuner when acquiring broadcasted pieces of content data. It goes without saying that the acquiring source from which the content acquiring unit 12 acquires a piece of content data may have such converting and tuning functions. Further, the content detecting unit 16, described later, may have the function for combining pieces of content data.

The reproducing unit 13 reproduces a piece of content data acquired by the content acquiring unit 12. For example, when the piece of content data includes a still image, the reproducing unit 13 reproduces the still image. On the other hand, the piece of content data includes a moving image, the reproducing unit 13 may reproduces the moving image as a dynamic image, or may reproduce the moving image as a still image. To reproduce the moving image as a still image means to reproduce one clip (one still image) of the piece of content data of the moving image. Hereinafter, the moving image or the still image obtained as a result of reproducing a piece of content data is called simply “image”. Further, when the piece of content data includes sound data, the reproducing unit 13 reproduces the sounds. The reproduction by the reproducing unit 13 includes not only the actual reproduction of music, images, and the like but also display of a piece of attribute information added to the piece of content data on the display screen.

The reproducing unit 13 can reproduce not only a piece of content data acquired by the content acquiring unit 12 but also a piece of content data detected by the content detecting unit 16. In this case, the reproducing unit 13 reproduces the piece of content data detected by the content detecting unit 16 similarly to the piece of content data acquired by the content acquiring unit 12. Further, the reproducing unit 13 can reproduce a plurality of pieces of content data simultaneously.

The display control unit 14 displays at least one of an image and a piece of attribute information reproduced by the reproducing unit 13 on the display screen (not show). When the reproducing unit 13 reproduces a plurality of pieces of content data simultaneously, the display control unit 14 can display a plurality of images simultaneously reproduced by the reproducing unit and a plurality of pieces of attribute information on the display screen simultaneously. At this time, the display control unit 14 can display the plurality of images and the plurality of pieces of attribute information on the display screen in a format of a list showing cycles, described later (for example, see FIG. 10). The display control unit 14 is again described in the description of the content detecting unit 16 and the like.

The sound output unit 15 acquires a sound signal reproduced by the reproducing unit 13 so as to output the sound signal. For this reason, the sound output unit 15 may have an amplifier (not shown), a speaker (not shown), or the like. The sound output unit 15 may have a connection terminal to be connected to an external sound output apparatus such as an external speaker or a headphone, and may output a sound to the external sound output apparatus via the output terminal. When the reproducing unit 13 reproduces a plurality of contents simultaneously, the sound output unit 15 can also output the plurality of sounds simultaneously similarly to the display control unit 14.

The content detecting unit 16 detects another piece of content data corresponding to the piece of content data being reproduced by the reproducing unit 13 (that is to say, the piece of content data acquired by the content acquiring unit 12) based on predetermined information. A detection source where the piece of content data is detected by the content detecting unit 16 is not particularly limited similarly to the content acquiring unit 12. Examples of the detection source includes the abovementioned content storage unit 11, the broadcasting wave of ground wave, satellite wave or the like, and a content distributing server (not shown) which publishes content on a network such as the Internet.

Here, the piece of content data detected by the content detecting unit 16 may be in a format, in which a content included in the piece of content data can not be normally read, such as a combination of a plurality of pieces of abovementioned data, compressed data, or encoded data. If the piece of content data is in such format, the content detecting unit 16 may convert the detected piece of content data into a readable format, by converting back to the plurality of pieces of information, decompressing or decoding, similarly to the content acquiring unit 12. Further, when the content detecting unit 16 may serve as a tuner when detecting broadcasted pieces of content data. It goes without saying that the detection source where the content detecting unit 16 detects the piece of content data may have such converting and tuning functions. Further, the content detecting unit 16 and the content acquiring unit 12 individually have the content data decoding function, or the like. Such functions may be provided to one of the content detecting unit 16 and the content acquiring unit 12 to be shared. Further, a unit other than the content detecting unit 16 and the content acquiring unit 12 may be configured to have these functions.

The content detecting unit 16 detects piece of content data based on the following information.

First detection: cycle information representing a cycle determined by the cycle determining unit 17, described later

Second detection: related information representing predetermined relationship determined by the relationship determining unit 18, described later

Third detection: a piece of preference information representing user's preference extracted by the preference information extracting unit 19, described later

These detections are described in detail in the respective configurations.

The cycle determining unit 17 determines a temporal corresponding relationship between a piece of content data to be detected by the content detecting unit 16 and a piece of content data acquired by the content acquiring unit and being reproduced by the reproducing unit 13. At this time, the cycle determining unit 17 determines a predetermined “cycle” as the temporal corresponding relationship. One cycle represents a repetition unit of a calendar, and its examples include a day, a week, a month, a year and the like. One cycle may be a plurality of days, weeks, months, years and the like, namely, for example, alternate weeks, every two weeks, every four years. The human life is built based on cyclic nature such that every Saturday and Sunday are off and every May has a long holiday. Therefore, a lot of users normally take a cyclic course of action. For example, users who view news programs or drama series every day have a high possibility of viewing the same programs in the same time zone. Further, users who view drama series broadcasted every week have a high possibility of viewing the same program in the same time zone on the same day of the week. Further, a lot of users regularly view programs which are broadcasted in a determined time zone on a determined day every year, such as “Kohaku Uta Gassen” or special programs broadcasted during the Bon period. Many users take special actions on memorial days such as birthday, wedding anniversary, Valentine's day, travel on the Bon holidays and homecoming on New Year's Holidays, and thus the users frequently photograph images on such days. The cyclic user's actions are normally taken according to the calendar. The cycle determining unit 17, therefore, determines a cycle to be a repetition unit on the calendar according to which the user's actions are repeated. At this time, the cycle determining unit 17 can determine not only one cycle but also a plurality of cycles.

When the cycle determining unit 17 determines a cycle, the content detecting unit 16 detects another piece of content data corresponding to a piece of content data being reproduced based on the determined cycle (first detection).

The detection is described concretely. The content detecting unit 16 acquires a piece of time information about the piece of content data acquired by the content acquiring unit 12 and being reproduced by the reproducing unit 13 from the content acquiring unit 12 or the reproducing unit 13. The content detecting unit 16 detects another piece of content data having the piece of time information representing another time point one cycle, which is determined by the cycle determining unit 17 based on the acquired piece of time information, before or after one time point in a piece of time information. Thereafter, the detected piece of content data is sent to the reproducing unit 13, and the reproducing unit 13 reproduces the piece of content data detected by the content detecting unit 16 as well as the a piece of content data being reproduced. The display control unit 14 displays at least one of an image and a piece of attribute information of the piece of content data detected by the content detecting unit 16 and reproduced as well as at least one of an image and a piece of attribute information of the piece of content data being reproduced.

The outlines of the determination of the cycle by the cycle determining unit 17 and the first detection by the content detecting unit 16 using the determined result are described by giving examples with reference to FIGS. 3 to 6. In the outline described below, the time point represented in the piece of time information about the piece of content data being reproduced (for example, broadcasted time, recorded time or acquired time) is assumed to be “Monday/Jul./7/2008/17:00”. However, it is obvious that the embodiment of the present invention is not limited to this time point.

FIG. 3 illustrates a case where the cycle determining unit 17 determines one cycle to be “one day”.

As shown in FIG. 3, the content detecting unit 16 detects another piece of content data of the cycle, which is one or more days before or after, based on the piece of time information about the piece of content data being reproduced.

As described above, it is assumed that the piece of time information about the piece of content data being reproduced is “Monday/Jul./7/2008, 17:00”. In this case, the content data detecting unit 16 detects another piece of content data having piece of time information such as July 6 which is one day before, July 5 which is two days before, and July 8 which is one day after with respect to July 7.

At this time, the content detecting unit 16 desirably detects a piece of content data having a piece of time information having the same value in one or more step smaller repetition unit than one cycle as that of the piece of time information about the piece of content data being reproduced. That is to say, when one cycle shown in FIG. 3 is one day, the content detecting unit 16 can detect a piece of content data whose value of the repetition unit “hour”, which is one step smaller than cycle “day”, is the same. In this case, the content detecting unit 16 also can detect a piece of content data whose value of the repetition unit “hour and minute”, which is two steps smaller than the cycle “day”, is the same.

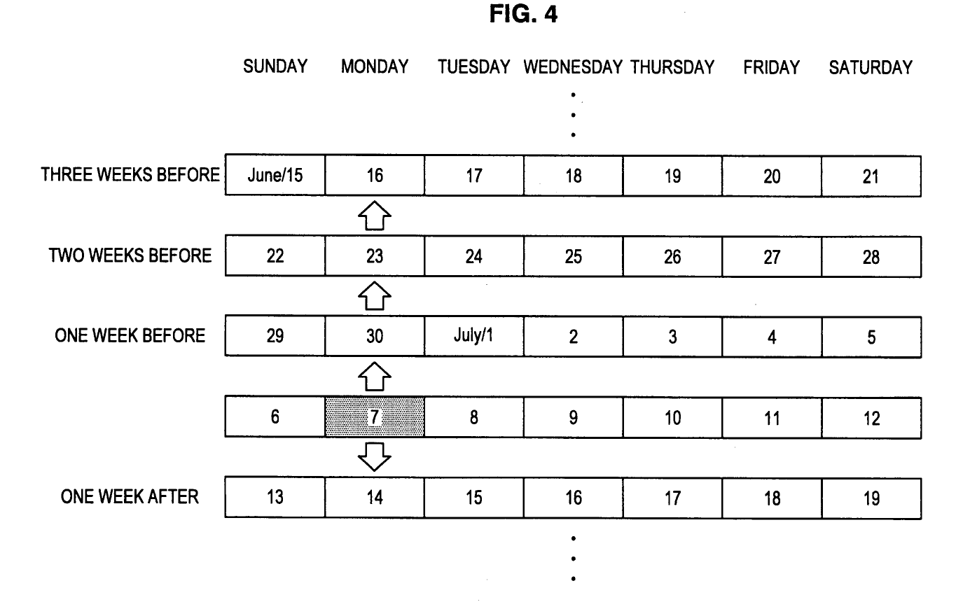

FIG. 4 illustrates a case where the cycle determining unit 17 determines one cycle to be “one week”.

As shown in FIG. 4, the content detecting unit 16 detects another piece of content data of the cycle, which is one or more weeks before or after, based on the piece of time information about the piece of content data being reproduced. As described above, it is assumed that the piece of time information about the piece of content data being reproduced is “Monday/Jul./7/2008/17:00”. In this case, the content detecting unit 16 detects another piece of content data having a piece of time information such as Monday/June/30 which is one week before, Monday/June/23 which is two weeks before and Monday/July/17 which is one week after with respect to Monday/July/7. One cycle of 7 days means the same as that of one week.

At this time, the content detecting unit 16 desirably detects a piece of content data having a piece of time information having the same value in one or more step smaller repetition unit than one cycle as that of the piece of time information about the piece of content data being reproduced. That is to say, when one cycle shown in FIG. 4 is one week, the content detecting unit 16 can detect a piece of content data whose value of the repetition unit “day”, which is one step smaller than “week”, is the same. In this case, the content detecting unit 16 also can detect a piece of content data whose value of the repetition unit “day and hour” or “day and hour and minute”, which is two or more steps smaller than the cycle “week”.

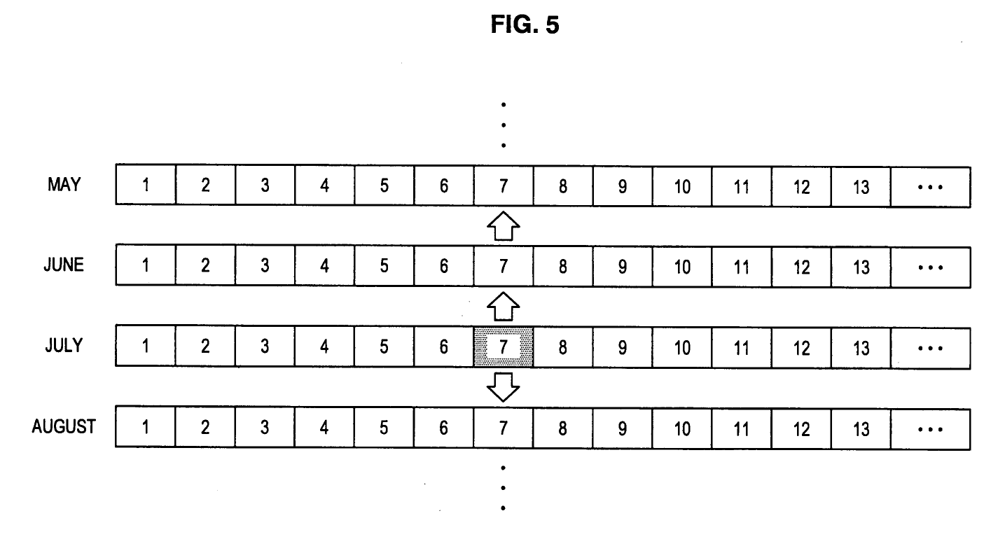

FIG. 5 illustrates a case where the cycle determining unit 17 determines one cycle to be “one month”.

As shown in FIG. 5, the content detecting unit 16 detects another piece of content data of the cycle, which is one or more months before or after, based on the piece of time information about the piece of content data being reproduced.

As described above, it is assumed that the piece of time information about the piece of content data being reproduced is “Monday/Jul./7/2008/17:00”. In this case, the content detecting unit 16 detects another piece of content data having a piece of time information such as July which is one month before, May which is two months before and August which is one month after with respect to July.

At this time, the content detecting unit 16 desirably detects a piece of content data having a piece of time information having the same value in one or more step smaller repetition unit than one cycle as that of the piece of time information about the piece of content data being reproduced. That is to say, one cycle shown in FIG. 5 is one week, the content detecting unit 16 can detect a piece of content data whose value of the repetition unit “day”, which is two steps smaller than “month”, is the same. In this case, the content detecting unit 16 also can detect a piece of content data, whose value of the repetition unit “week”, which is one step smaller than “month” or “day and hour” and “day and hour and minute” which are three or more steps smaller than “month”. For example, when a piece of content data whose vale of “day” is the same is detected, the content detecting unit 16 detects another piece of content data having a piece of time information such as June 7 which is one month before, May 7 which is two months before and August 7 which is one month after with respect to July 7 as shown in FIG. 5. In this case, the content detecting unit 16 desirably ignores the repetition unit “week” which is one step smaller than “month”.

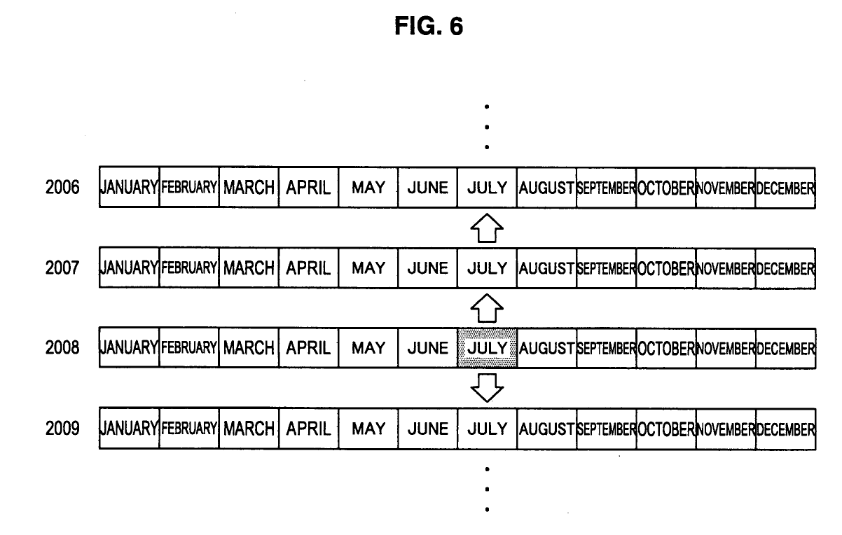

FIG. 6 illustrates a case where the cycle determining unit 17 determines one cycle to be “one year”.

As shown in FIG. 6, the content detecting unit 16 detects another piece of content data of the cycle, which is one or more years before or after, based on the piece of time information about the piece of content data being reproduced.

As described above, it is assumed that the piece of time information about the piece of content data being reproduced is “Monday/Jul./7/2008/17:00”. In this case, the content detecting unit 16 detects another piece of content data having a piece of time information such as 2007 which is one year before, 2006 which is two years before and 2009 which is one year after with respect to 2008.

At this time, similarly to the abovementioned cases, the content detecting unit 16 desirably detects a piece of content data having a piece of time information having the same value in one or more step smaller repetition unit than one cycle as that of the piece of time information about the piece of content data being reproduced. That is to say, when one cycle shown in FIG. 5 is one year, the content detecting unit 16 can detect a piece of content data whose value of the repetition unit “month”, which is one step smaller than “year”, is the same. In this case, the content detecting unit 16 also can detect a piece of content data, whose value of the repetition unit “month and day”, “month, day, and hour” and “month, day, hour, and minute” which is two or more steps smaller than “year”. For example, when the piece of content data whose value of “month” is the same is detected, the content detecting unit 16 detects another piece of content data having a piece of time information such as July 2007 which is one year before, July 2006 which is two years before and July 2009 which is one year after with respect to July 2008 as shown in FIG. 6. The content detecting unit 16 desirably detects a piece of content data having the same value in two steps smaller repetition unit “month and day” than the cycle “year”.

The description returns to the cycle determining unit 17.

The cycle determining unit 17 further determines a range where the content detecting unit 16 detects a piece of content data. That is to say, the cycle determining unit 17 determines pieces of content data of how many cycles before or how many cycles after with respect to the piece of time information about the piece of content data being reproduced is to be detected. In other words, the cycle determining unit 17 determines the number of cycles which is to go back or forward in time when the content detecting unit 16 detects a piece of content data. The number of cycles which is to go back in time or the number of cycles which is to go forward in time, namely, the detection range is also called “cycle number”.

On the other hand, when the cycle number or the cycle is determined, the cycle determining unit 17 can determine various cycle numbers and cycles. The determination which is made based on the following information is described as an example of the determination of the cycles.

First cycle determination: a piece of operating time information representing an operating time length of the display apparatus 10

Second cycle determination: a piece of attribute information representing attribute of the piece of content data being reproduced

In order to determine cycles and the like, the cycle determining unit 17 has a first cycle determining unit 171 and a second cycle determining unit 172. Therefore, the first cycle determination and the second cycle determination as well as the configurations of these units are described below.

The first cycle determining unit 171 determines a cycle and cycle numbers according to the operating time length of the display apparatus 10 based on the piece of operating time information representing the operating time length. Here, the operating time length means elapsed time for which the display apparatus 10 is continuously used or elapsed time from the display apparatus 10 is purchased or installed, for example. That is to say, when the operating time length is the elapsed time of continuous operation, it means a continuous operating time length in one operation of the display apparatus 10, and when it is the elapsed time from the installation or the like, it means an accumulated operating time length in a plurality of operation of the display apparatus 10 (for example, the number of operating times).

At this time, the first cycle determining unit 171 can set the cycle in such a manner that the longer the operating time length becomes, the shorter the cycle becomes. On the contrary, the first cycle determining unit 171 desirably determines the cycle in such a manner that the longer the operating time length becomes, the longer the cycle becomes. Similarly, the first cycle determining unit 171 can determine the cycle number in such a manner that the longer the operating time becomes, the smaller the cycle number becomes. On the contrary, the first cycle determining unit 171 desirably determines the cycle number in such a manner that the longer the operating time length become, the larger the cycle number becomes.

An example of the operation of the first cycle determining unit 171 for determining the cycle to be longer and determining the cycle number to be larger when the operating time length becomes longer is described with reference to FIGS. 7 and 8. FIG. 7 illustrates the determination of the cycle, and FIG. 8 illustrates the determination of the cycle number.

As shown in FIG. 7, the first cycle determining unit 171 determines the cycle to be longer as the operating time length of the display apparatus 10 becomes longer. In the example shown in FIG. 7, in a period A where the operating time length is t0 to t1, the first cycle determining unit 171 determines the cycle to be “day”. When the operating time length becomes longer, the first cycle determining unit 171 determines the cycle to be “week” in a period B where the operating time length is t1 to t2. When the operating time becomes still longer, the first cycle determining unit 171 determines the cycle to be “month” in a period C where the operating time length is t2 to t3, and determines the cycle to be “year” in a period D where the operating time length is t3 to t4. Thereafter, the first cycle determining unit 171 determines the cycle to be longer such as “two years, three years”.

On the other hand, as shown in FIG. 8, the first cycle determining unit 171 determines the cycle number to be larger as the operating time length of the display apparatus 10 becomes longer. In the example shown in FIG. 8, in the period A where the operating time length is t0 to t1, the first cycle determining unit 171 determines the detecting range, namely, the cycle number to be larger gradually from 1 to N while determining the cycle to be “day”. When the operating time length becomes longer and in the period B where the operating time length is t1 to t2, the first cycle determining unit 171 determines the cycle number to be larger gradually from 1 to N again while determining the cycle to be “week”. When the operating time becomes longer and in the period C where the operating time length is t2 to t3 or in the period D where the operating time length is t3 to t4, the first cycle determining unit 171 determines the cycle number to be larger gradually from 1 to N similarly while determining the cycle to “month” or “year”.

When the first cycle determining unit 171 changes at least one of the cycle and the cycle number (particularly the cycle), the display apparatus 10 according to the embodiment can determine the temporary range for detecting content to be gradually wide.

When the operating time length is the accumulated operating time length, the display apparatus 10 can determine the cycle to be longer or the cycle number to be larger as the operating time length becomes longer. That is to say, as a piece of content data to be provided by the display apparatus 10, that of one or a several days before or after is detected at the beginning of the operation where a user does not get used to the display apparatus 10. As the accumulated operating time length becomes longer and the user gets used to the display apparatus 10, a piece of content data of one to a several weeks, one to a several months and one to a several years before or after is detected. The cycle is made to be longer gradually in this manner, the user is allowed to easily recognize the cyclic nature of the detection in the display apparatus 10 according to the embodiment, thereby improving user's operability and convenience of the display apparatus 10.

Further, when the operating time length is the continuous operating time length, the display apparatus 10 can also determine the cycle to be longer or the cycle number to be larger as the operating time length becomes longer. That is to say, as a piece of content data to be provided by the display apparatus 10, that of one or a several days before or after is detected at the beginning of the operation of the display apparatus 10. As the continuous operating time length becomes longer, a piece of content data of one to a several weeks, one to a several months and one to a several years before or after is detected. Normally, user's thought is established by association. That is to say, a user who views one piece of content data typically associates pieces of content data which can be associated with the piece of content data, such as a piece of content data which is temporarily closer to the piece of content data. A user typically further associates another piece of content data with the associated piece of content data, then sequentially associate pieces of content data temporarily farther from the associated piece of content data. The display apparatus 10 according to the embodiment, therefore, determines the cycle gradually longer so as to be capable of allowing a user to associate from temporarily close pieces of content data to temporarily far pieces of content data. Therefore, the display apparatus 10 can detect a piece of content data corresponding to the user's association, and thus pieces of content data which match with user's thought and preference can be provided. The method for providing pieces of content data while assisting such association is expected to enable users' brain training.

The description refers to the case where the first cycle determining unit 171 determines the cycle to be longer and the cycle number to be larger, but the cycle number may be fixed to a predetermined number in advance, and also the cycle may be fixed similarly.

The second cycle determining unit 172 determines a cycle based on a piece of attribute information about the piece of content data which is acquired by the content acquiring unit 12 and is being reproduced by the reproducing unit 13. The determination is described more concretely. The second cycle determining unit 172 acquires the a piece of attribute information about the piece of content data acquired by the content acquiring unit 12 and being reproduced by the reproducing unit 13 from the content acquiring unit 12 or the reproducing unit 13. The second cycle determining unit 172 determines a cycle suitable for the attribute of the content based on the acquired piece of attribute information.

A concrete example of the determination of the cycle according to the piece of attribute information is described.

For example, when the attribute of the content represents “news”, the content is likely to be broadcasted in the same time zone every day. Therefore, the second cycle determining unit 172 determines the cycle to be “day” in this case.

For example, when the attribute of the content expresses “weekly drama”, the content is likely to be broadcasted in the same time zone every week. Therefore, the second cycle determining unit 172 determines the cycle to be “week” in this case.

For example, when the attribute of the content expresses “birthday”, similar contents are likely to be present for the same date every year. Therefore, the second cycle determining unit 172 determines the cycle to be “year” in this case.

For example, when the attribute of the content expresses “travel on summer holiday”, similar contents are likely to be present for the same period every year (for example, the bon holiday). Therefore, the second cycle determining unit 127 determines the cycle to be “year” in this case.

For example, when the attribute of the content expresses “the Summer Olympics”, the content is likely to be broadcasted at the same period every four years. Therefore, the second cycle determining unit 172 determines the cycle to be “four year” in this case.

The second cycle determining unit 172 can determine a cycle suitable for attribute based on the piece of attribute information about a piece of content data in such manner. Users' actions typically have specific cyclic nature, but the cycle length varies according to objects of users' interests. Therefore, the display apparatus 10 have the second cycle determining unit 172 so as to be capable of determining a cycle according to attribute of a piece of content data being reproduced. As a result, the display apparatus 10 specifies cyclic nature of users' interests so as to be capable of providing content corresponding to users' thought, liking and taste.

The determination of cycle based on attribute by means of the second cycle determining unit 172 in this manner can be realized by various methods. For example, the second cycle determining unit 172 may have a storage unit (not shown) in which a keyword and a cycle are recorded while related with each other, and detect whether a piece of attribute information includes a keyword. When the corresponding keyword is present, the second cycle determining unit 172 can determine a cycle related with the keyword. At this time, the second cycle determining unit 172 can also detect that the piece of attribute information includes a term or a word which is conceptually close to a keyword.

The first cycle determination by the first cycle determining unit 171 and the second cycle determination by the second cycle determining unit 172 are described above. However, the cycle determining method in the cycle determining unit 17 according to the embodiment is not limited to this example. Cycles can be determined based on other various pieces of information. For example, it goes without saying that a cycle can be determined based on operation information output from a controller or the like when a user operates the controller or the like. Further, it goes without saying that the first cycle determination and the second cycle determination may be performed simultaneously, or only one of them may be performed.

The remaining configuration of the display apparatus 10 and the second detection and the third detection by the content detecting unit 16 are described with reference to FIG. 1 again.

The relationship determining unit 18 determines relationship between a piece of attribute information about a piece of content data being reproduced and a piece of attribute information about a piece of content data to be detected by the content detecting unit 16. The content detecting unit 16 detects a piece of content data having a piece of attribute information having the determined relationship with the piece of attribute information about the piece of content data being reproduced based on the determined relationship (second detection).

The operation is described more concretely. The relationship determining unit 18 acquires the piece of attribute information about the piece of content data being reproduced from the content acquiring unit 12 or the reproducing unit 13. The relationship determining unit 18 selects one or more attributes from the acquired piece of attribute information so as to determine relationship with the attributes. The content detecting unit 16 detects a piece of content data having a piece of attribute information having the determined relationship with the selected attributes. Thereafter, the detected piece of content data is sent to the reproducing unit 13, and the reproducing unit 13 reproduces the piece of content data detected by the content detecting unit 16 as well as the piece of content data being reproduced. The display control unit 14 displays at least one of an image and the piece of attribute information of the piece of content data being reproduced as well as at least one of an image and the piece of attribute information of the piece of content data detected by the content detecting unit 16 and reproduced on the display screen.

The relationship determined by the relationship determining unit 18 is an attribute selected to be used for the second detection, or a level of the relationship to be detected.

Examples of the piece of attribute information to be used for the second detection include names of content, genre of content, information about performers and producers, type of content (for example, moving image, still image or sound), and production place of content, for example. However, the attributes selected by the relationship determining unit 18 are not limited to the examples.

For example, the level of the relationship used by the second detection includes perfect matching of attributes, partial matching of attributes, inclusion of attributes and conceptual closeness of attributes. However, the level of the relationship determined by the relationship determining unit 18 is not limited to the examples.

When the relationship is determined, the relationship determining unit 18 can determine the relationship based on at least one of the piece of attribute information about the content being reproduced and the cycle determined by the cycle determining unit 17.

For example, when the attribute of the content is music, a piece of content data which attracts a user's interest is typically the music of the same genre and of the same artist or of artists including the artist. Therefore, the relationship determining unit 18 can select a genre and an artist, and can determine the level of the relationship to be matching for the genre and at least inclusion for the artist as attributes to be used for the second detection.

For example, when the cycle determined by the cycle determining unit 17 is “year”, a user typically gets interested in a piece of content data created by the user on annual memorial days in the pieces of content data of the same month (or month and day) as that of the piece of content data being reproduced. In this case, therefore, the relationship determining unit 18 can select a producer or a name of the content and can determine the level of the relationship as at least inclusion for the producer and conceptual closeness for the name of content as the attributes to be used for the second detection.

For example, when the cycle determined by the cycle determining unit 17 is “week” or “day”, a piece of content data which attracts an user's interest is likely to be a program broadcasted every week or every day. In this case, therefore, the relationship determining unit 18 can select a broadcasting channel and can determine the level of the relationship as matching as the attribute to be used for the second detection.

For example, if the first cycle is determined in order to improve the user's operability, when the cycle determined by the cycle determining unit 17 becomes longer, the user is expected to get used to the display apparatus 10. Therefore, the relationship determining unit 18 can select an attribute which is easily associated such as the same genre as the attribute to be used for the second detection, whereas can change the attribute variously when the cycle becomes longer.

The above relationship determining method is only an example, and it goes without saying that a lot of variations can be considered.

The second detection based on the relationship determined by the relationship determining unit 18 may be independently performed, but it may be combined with the first detection based on the cyclic nature. For example, when the second detection is performed after the first detection, a plurality of pieces of content data detected by the first detection based on the cyclic nature can be further narrowed down into pieces of content data related with the attributes of the piece of content data being currently viewed by the user. Therefore, the display apparatus 10 can prevent a piece of content data accidentally having cyclic nature from being detected, and can provide a piece of content data which matches with user's thought and interest.

The preference information extracting unit 19 extracts a piece of preference information representing user's preference based on an operating state of the display apparatus 10. The content detecting unit 16 detects a piece of content data having a piece of attribute information matching with the extracted piece of preference information (third detection).

The operation is described more concretely. The preference information extracting unit 19 can extract an attribute of a piece of content data that is frequently viewed or a common attribute of pieces of content data that are viewed from past reproducing history as the piece of preference information, for example. Also the preference information extracting unit 19 can be connected to an external camera or a sound input apparatus (not shown), analyze a direction and an expression of a face, a voice tone and viewing time. The preference information extracting unit 19 detects a level of user's concentration or a level of user's interest with respect to the piece of content data being reproduced, and extract attributes of a piece of content data with high concentration level or high interest level as the piece of preference information. Further, the preference information extracting unit 19 can set a piece of preference information based on an operation signal according to a user's operation, so that the user can set the piece of preference information. The content detecting unit 16 detects a piece of content data having the piece of attribute information including that piece of preference information based on the piece of preference information. Thereafter, the detected piece of content data is sent to the reproducing unit 13, and the reproducing unit 13 reproduces the piece of content data detected by the content detecting unit 16 as well as the piece of content data being reproduced. The display control unit 14 displays at least one of the image and the piece of attribute information of the piece of content data detected by the content detecting unit 16 and reproduced as well as at least one of the image and the piece of attribute information of the piece of content data being reproduced on the display screen.

The third detection based on the piece of preference information extracted by the preference information extracting unit 19 may be performed independently, but the third detection may be combined with the first detection based on the cyclic nature and the second detection based on the relationship. When the third detection is performed after the first and second detections, a plurality of pieces of content data detected by the first detection based on the cyclic nature and second detection can be further narrowed down into pieces of content data which match with user's preference. Therefore, the display apparatus 10 can prevent a piece of content data accidentally having cyclic nature and the same attributes from being detected, and can provide a piece of content data which match with user's thought and interest.

### 2. Operation of the Display Apparatus

The configuration of the display apparatus 10 according to the embodiment is described above.

The operation of the display apparatus 10 according to the embodiment is described below with reference to FIG. 9.

FIG. 9 is an explanatory diagram explaining the operation of the display apparatus according to the embodiment.

As shown in FIG. 9, step S01 is executed first.

At step S01, the cycle determining unit 17 determines a cycle. At this time, a plurality of cycles may be determined by the first cycle determination, the second cycle determination or user's setting. The process goes to step S03.

At step S03 (one example of a content detecting step), the content detecting unit 16 performs the first detection, namely, detects a piece of content data based on the cyclic nature. The process goes to step S05.

At step S05, the relationship determining unit 18 determines relationship to be used for detection based on the cycle determined at step S01 or the piece of attribute information of a piece of content data being reproduced. The process goes to step S07.

At step 07, the content detecting unit 16 performs the second detection, namely, detects a piece of content data based on the relationship of a piece of attribute information with respect to the detected result at step S03 or independently from the detected result at step S03. The process goes to step S09.

At step S09, the content detecting unit 16 performs the third detection, namely, detects a piece of content data based on the piece of preference information extracted by the preference information extracting unit 19 in advance with respect to the detected result at step S01 or the like or independently from the detected result. The process goes to step S11.

At step S11, the display control unit 14 determines a display format of a plurality of contents to be reproduced by the reproducing unit 13. That is to say, when the plurality of pieces of content data is detected at steps S03, S07 and S09, the display control unit 14 can display images or pieces of attribute information of these pieces of content data in a list showing the cycles. Therefore, at step S1, the display control unit 14 determines whether to display the list and in which format, the list is displayed when determined to display the list. The process goes to step S13.

At step S13 (display control step), the display control unit 14 displays at least one of the image and the piece of attribute information of the piece of content data detected at step S03 or the like as well as at least one of the image and the piece of attribute information of the piece of content data being reproduced on the display screen. The process goes to step S15.

At step S15, the display apparatus 10 checks whether an operation for providing another piece of content data related with the piece of content data being reproduced is to be ended. When the operation is to be ended, the display apparatus 10 ends the operation, and when the operation is not to be ended, the process starting from step S01 is repeated.

### 3. Operational Example of the Display Apparatus

An example of a piece of content data to be displayed on the display screen of the display apparatus 10 and provided to a user through these steps as well as an example of the list by the display control unit 14 is described below. FIG. 10 is an explanatory diagram describing one example of the operation of the display apparatus according to the embodiment.

In FIG. 10, a piece of content data X being reproduced is displayed on the display screen M. FIG. 10 shows a state where the cycle determining unit 17 determines a plurality of cycles (“day”, “week”, “month”, “year”), and does not determine another cycle “10 years”, “user setting”). In the example of FIG. 10, a starting point of a cycle, namely, a piece of time information about the piece of content data X is “Monday/Jul./7/2008/17:00” similarly to the above description. The display control unit 14 displays a plurality of pieces of content data as the detected result by the content detecting unit 16 in a format of a list L showing the cycles of day, week, month and year. That is to say, the list L is displayed on the left side on the display screen M, and pieces of content data A1 and A2 detected based on the cycle “day” are displayed on a first column of the list L. On the other hand, pieces of content data B1 and B2 detected based on the cycle “week” are displayed on a second column of the list L. Further, pieces of content data C2 and C3 detected based on the cycle “month” are displayed on a third column of the list L. Here, a user can operate the controller (not shown) and select a button P so as to display another piece of content data which is not included in the list L. Also, the user can operate the controller (not shown) and point a cursor CA to any piece of content data, so as to reproduce a moving image of the piece of content data or enlarging the piece of content data. Further, pieces of content data D1 and D2 detected based on the cycle “year” are displayed on a fourth column of the list L.

The list L shown in FIG. 10 is one example, and the display control unit 14 can display various lists showing cycles on the display screen M.

### 4. Example of Effect

The above describes the display apparatus 10 according to the first embodiment of the present invention.

The display apparatus 10 can provide another piece of content data having predetermined cyclic nature with respect to a piece of content data being reproduced. Therefore, the display apparatus 10 can provide pieces of content data having relationship closely related with actual users' cyclic lives regardless of types of the pieces of content data. The time axis having such cyclic nature is common to approximately all users, and the users frequently use and think such cyclic nature on a daily basis. Therefore, the display apparatus 10 can provide pieces of content data suitable for all users independent of the users but in a form as if matching with a process of association and remembering events by the users, in a novel and bold manner. More specifically, even when two pieces of content data seem to be unrelated with each other like a party on consecutive holidays of this year and driving on consecutive holidays of the last year, the display apparatus 10 can provide the two pieces of content data in association.

The display apparatus 10 can detect a piece of content data which can not be detected according to matching of the piece of attribute information and a piece of time information. As a result, the display apparatus 10 prevents only fixed pieces of content data from being detected, and can rotate pieces of content data to be provided.

It should be understood by those skilled in the art that various modifications, combinations, sub-combinations and alterations may occur depending on design requirements and other factors insofar as they are within the scope of the appended claims or the equivalents thereof.

For example, in the above embodiment, it is described a case where the content detecting unit 16 detects another piece of content data corresponding to the piece of content data which is acquired by the content acquiring unit 12 and is being reproduced by the reproducing unit 13. However, the embodiment of the present invention is not limited to this example. The content detecting unit 16 can also detect another piece of content data corresponding to the piece of content data detected by the content detecting unit 16 itself and reproduced by the reproducing unit 13. In this case, the content detecting unit 16 acquires a piece of time information or the like about the piece of content data being reproduced from the content detecting unit 16 itself, the reproducing unit 13, or the like so as to detect another content similarly to the first embodiment.

A series of the process described above embodiment may be executed by a dedicated hardware, but may be executed by software. When the series of the process is executed by software, the series of the process described above can be realized by executing a program on a general-purpose or dedicated computer. The computer may have a CPU (Central Processing Unit), a storage device such as an HDD (Hard Disc Drive), a ROM (Read Only Memory) and a RAM (Random Access Memory), a communication device connected to a network such as a LAN (Local Area Network) and the Internet, an input device such as a mouse and a keyboard, a magnetic disc such as a flexible disc, an optical disc such as a CD (Compact Disc), an MO (Magneto Optical) disc and a DVD (Digital Versatile Disc), a drive which writes/reads data in/from a removal storage medium such as a semiconductor memory, a display device such as a monitor, an output device such as a sound output device such as a speaker and a headphone, and the like. The computer executes a program recorded in the recording device or the removal storage medium, or a program acquired via a network so as to execute the series of the process.

In this specification, the steps described in the flowchart may be processed in the temporal sequence as described above, also the steps may be processed not in the temporal sequence but the steps processed in parallel or individually. Also it is obvious that even when the steps are processed in a temporal sequence, the order of the steps can be suitably changed depending on cases.

What is claimed is:

1. An information processing apparatus comprising:
a content detecting unit which detects a piece of content data having a piece of time information representing a time point that is a predetermined cycle before or after with respect to a time point represented by a piece of time information added to a piece of content data being reproduced; and
a display control unit which displays, on a display screen, at least one of a piece of attribute information added to the piece of content data detected by the content detecting unit and an image included in said piece of content data as well as at least one of a piece of attribute information added to the piece of content data being reproduced and an image included in said piece of content data.

2. The information processing apparatus according to claim 1, further comprising a first cycle determining unit which determines the predetermined cycle corresponding to an operating time length of the information processing apparatus.

3. The information processing apparatus according to claim 2, wherein the first cycle determining unit determines the predetermined cycle longer as the operating time length of the information processing apparatus becomes longer.

4. The information processing apparatus according to any one of claims 1, further comprising a second cycle determining unit which determines the predetermined cycle based on the piece of attribute information added to the piece of content data being reproduced.

5. The information processing apparatus according to claim 1, wherein
the content detecting unit detects a piece of content data having a piece of attribute information that has a predetermined relationship with the piece of attribute information added to the piece of content data being reproduced,
the information processing apparatus further comprises a relationship determining unit which determines the predetermined relationship based on the predetermined cycle.

6. The information processing apparatus according to claim 1, wherein one cycle of the predetermined cycle is a repetition unit of the calendar.

7. The information processing apparatus according to claim 6, wherein one cycle of the predetermined cycle is a day, a week, a month or a year.

8. The information processing apparatus according to claim 1, wherein
the content detecting unit detects a plurality of pieces of content data,
the display control unit displays, on the display screen, at least one of the piece of attribute information added to the piece of content data detected by the content detecting unit and an image included in the piece of content data in a list showing the predetermined cycles.

9. An information processing method comprising the steps of:
detecting a piece of content data having a piece of time information representing a time point that is a predetermined cycle before or after with respect to a time point represented by a piece of time information added to a piece of content data being reproduced; and
displaying, on a display screen, at least one of a piece of attribute information added to the piece of content data detected at the content detecting step and an image included in said piece of content data as well as at least one of a piece of attribute information added to the piece of content data being reproduced and an image included in the piece of content data being reproduced.
